(19) United States
(12) Patent Application Publication
(10) Pub. No.: US 2018/0204501 A1
(43) Pub. Date: Jul. 19, 2018

(54) Display Driving Circuit, Display Screen and Terminal Device

(71) Applicant: Wuhan China Star Optoelectronics Technology Co.,Ltd., Wuhan, Hubei (CN)

(72) Inventors: Chunpeng GUO, Shenzhen, Guangdong (CN); Xingling GUO, Shenzhen, Guangdong (CN)

(73) Assignee: Wuhan China Star Optoelectronics Technology Co., Ltd., Wuhan, Hubei (CN)

(21) Appl. No.: 15/119,662

(22) PCT Filed: Jul. 11, 2016
(86) PCT No.: PCT/CN2016/089611

§ 371 Date: Aug. 17, 2016

(30) Foreign Application Priority Data
Jun. 3, 2016 (CN) 201610392286.1

(51) Int. Cl. G09G 3/20

(52) U.S. Cl. CPC G09G 3/2085

(57) ABSTRACT

The present disclosure discloses a display driving circuit, a display screen and a terminal device. The display driving circuit comprises a driving IC, multiple scanning lines and multiple data lines; one kind of the scanning line and the data line is annular arrangement; the other kind of the scanning line and the data line is radial arrangement; the driving IC is connected to the scanning lines and the data lines. The present invention can be better adapted to circular, round or elliptical display panel.

### BACKGROUND OF THE INVENTION

### 1. Field of the Invention

The present disclosure relates to the fields of display technology, and in particular to a display driving circuit, a display screen and a terminal device.

### 2. The Related Arts

With the development of technology, the shape of the display screen of the smart devices is no longer restricted to square. Especially, in terms of the wearable device, circular, round or elliptical display screens are more and more. The display driving circuit of the traditional display screen is a pixel electrode arranged in matrix, the data line and the scanning line are introduced by a driving IC with crisscross-shaped arrangement. The pixel electrode and the switch are provided at the intersection of the data line and the scanning line. This kind of the display driving circuit is more difficult to arrange uniformly for circular, round or elliptical display panel.

### SUMMARY OF THE INVENTION

The technical issue to be solved by the present disclosure is to provide a display driving circuit, a display screen and a terminal device.

In view of this, the present disclosure provides a display driving circuit, a display screen and a terminal device, which can be better adapted to circular, round or elliptical display panel.

To solve the above technical problem, one aspect of the present disclosure is to provide a terminal device, comprising a display screen, the shape of the display screen being circular, round or elliptical; wherein, the display screen comprises a display driving circuit, the display driving circuit comprises a driving IC, multiple scanning lines and multiple data lines; one kind of the scanning line and the data line is annular arrangement; the other kind of the scanning line and the data line is radial arrangement; the driving IC is connected to the scanning lines and the data lines.

Wherein, the display driving circuit further comprises multiple switches and multiple pixel electrodes, the switches and the pixel electrodes are provided at the intersection of the data lines and the scanning lines, the switches are connected to the pixel electrodes, the scanning lines and the data lines.

Wherein, the display driving circuit further comprises a first substrate and a second substrate parallel and spaced with each other, the driving IC is provided at a central region of the first substrate; the scanning lines and the data lines are arranged on the surface of the second substrate.

Wherein, the scanning line is a gate line, the data line is a source line.

To solve the above technical problem, another aspect of the present disclosure is to provide a display driving circuit, comprising a driving IC, multiple scanning lines and multiple data lines; one kind of the scanning line and the data line being annular arrangement; the other kind of the scanning line and the data line being radial arrangement; the driving IC being connected to the scanning lines and the data lines.

Wherein, it further comprises multiple switches and multiple pixel electrodes, the switches and the pixel electrodes are provided at the intersection of the data lines and the scanning lines, the switches are connected to the pixel electrodes, the scanning lines and the data lines.

Wherein, it further comprises a first substrate and a second substrate parallel and spaced with each other, the driving IC is provided at a central region of the first substrate; the scanning lines and the data lines are arranged on the surface of the second substrate.

Wherein, the scanning line is a gate line, the data line is a source line.

To solve the above technical problem, another aspect of the present disclosure is to provide a display screen, comprising a display driving circuit of the display screen, the display driving circuit comprising a driving IC, multiple scanning lines and multiple data lines; one kind of the scanning line and the data line being annular arrangement; the other kind of the scanning line and the data line being radial arrangement; the driving IC being connected to the scanning lines and the data lines.

Wherein, the shape of the display screen is circular, round or elliptical.

Wherein, it further comprises multiple switches and multiple pixel electrodes, the switches and the pixel electrodes are provided at the intersection of the data lines and the scanning lines, the switches are connected to the pixel electrodes, the scanning lines and the data lines.

Wherein, it further comprises a first substrate and a second substrate parallel and spaced with each other, the driving IC is provided at a central region of the first substrate; the scanning lines and the data lines are arranged on the surface of the second substrate.

Wherein, the scanning line is a gate line, the data line is a source line.

In the display driving circuit, the display screen and the terminal device according to the present disclosure, the display driving circuit comprises a driving IC, multiple scanning lines and multiple data lines; one kind of the scanning line and the data line is annular arrangement; the other kind of the scanning line and the data line is radial arrangement; the driving IC is connected to the scanning lines and the data lines. Therefore, the display driving circuit according to the embodiment of the present disclosure is annular arrangement, which can be better adapted to circular, round or elliptical display panel. Moreover, it can simplify the driving procedure of the display driving circuit while displaying circular, round or elliptical images, which reduces the power consumption of display driving circuit.

### BRIEF DESCRIPTION OF THE DRAWINGS

FIG. 1 is a schematic structure of a display driving circuit according to the existing technology;

FIG. 2 is a schematic structure of the display driving circuit 100 according to the embodiment of the present disclosure; and

FIG. 3 is a schematic structure of the driving IC in the display driving circuit 100 according to the embodiment of the present disclosure.

### DETAILED DESCRIPTION OF THE PREFERRED EMBODIMENTS

To enable those skilled in the art to better understand the technical aspect of the present disclosure, the detailed descriptions accompanying drawings and the preferred embodiment of a display driving circuit, a display screen and a terminal device are as follows. In the drawings, to clear the device, it exaggerates the thickness of the layer and the size of the device. The same reference numerals throughout the specification and drawings are used to denote the same elements.

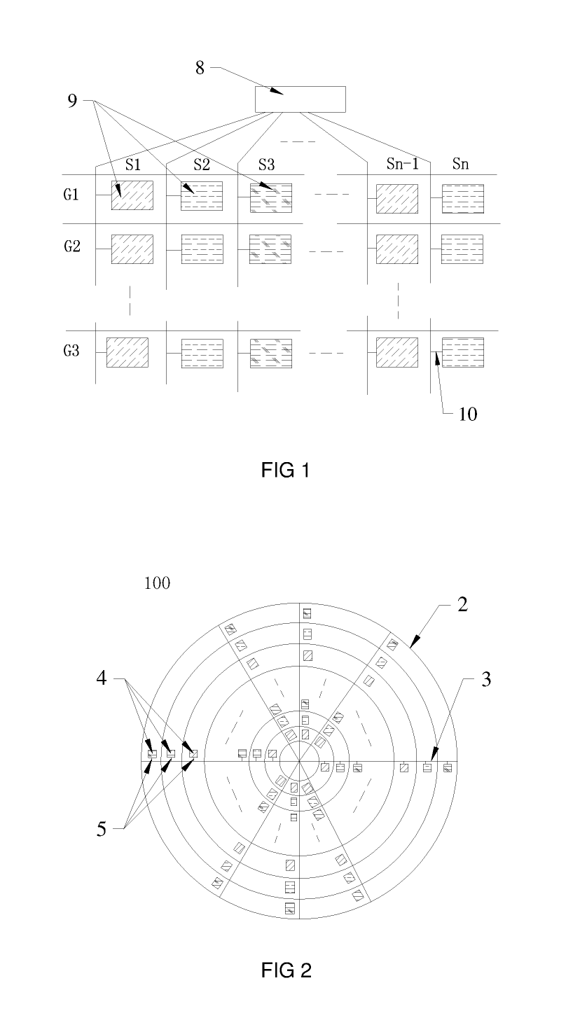

FIG. 1 is a schematic structure of a display driving circuit according to the existing technology. The driving IC 8 is provided on the substrate, the data lines S1˜Sn and the scanning lines G1˜Gn are provided on the surface of the substrate, as shown in FIG. 1. The data lines S1˜Sn and the scanning lines G1˜Gn are crisscross-shaped arrangement. The one with lateral arrangement is scanning lines G1˜Gn, the one with longitudinal arrangement is data lines S1˜Sn; the scanning lines G1˜Gn may also be longitudinal arrangement, and the data lines S1˜Sn may also be lateral arrangement. The shaded rectangle in FIG. 1 is a pixel electrode 9. A switch 10 and the pixel electrode 9 are provided at the intersections of the data lines S1˜Sn and the scanning lines G1˜Gn. The switch 10 is used to connect with the pixel electrode 9, the data lines S1˜Sn, and the scanning lines G1˜Gn. The working principle thereof is that the driving IC 8 outputs the pixel voltage and the control signal to the data lines S1˜Sn and the scanning lines G1˜Gn, the scanning lines G1˜Gn receives the control signal output from the driving IC 8 to control the switch 10 to turn on or off, the data lines S1˜Sn receive the pixel voltage and charge to the corresponding pixel electrode 9. During the driving process of the display panel, the scanning lines G1˜Gn control each row or each column of switch 10 to turn on or off sequentially, in the period of each row or each column of switch 10 turning on, the data lines S1˜Sn charge the row or the column of pixel electrode 11 the corresponding pixel voltage to display the screen. The traditional display driving circuit shown in FIG. 1 is more difficult to arrange uniformly for circular, round or elliptical display panel. Moreover, when the display panel displays circular patterns, each scanning line G1˜Gn and each data line S1˜Sn need to be driven. Thus, the driving procedure is more complex and more power consumption.

FIG. 2 is a schematic structure of the display driving circuit 100 according to the embodiment of the present disclosure.

Referring to FIG. 2, the display driving circuit 100 according to the embodiment of the present disclosure comprises a driving IC 1, multiple scanning lines 2 and multiple data lines 3. The scanning lines 2 are annular arrangement. The data lines 3 are radial arrangement. The driving IC 1 is connected to the scanning lines 2 and the data lines 3.

Moreover, the data lines 3 can also be annular arrangement, and the scanning lines 2 can be radial arrangement. The driving IC 1 is connected to the scanning lines 2 and the data lines 3.

The display driving circuit 100 according to the embodiment of the present disclosure discloses the arrangement of the scanning lines 2 and the data lines 3, so that the display driving circuit according to the embodiment is annular arrangement, which can be better adapted to circular, round or elliptical display panel.

Wherein, the display driving circuit 100 according to the embodiment of the present disclosure further comprises multiple switches 5 and multiple pixel electrodes 4. The switches 5 and the pixel electrodes 4 are provided at the intersection of the data lines 3 and the scanning lines 2. The switches 5 are connected to the pixel electrodes 4, the scanning lines 2 and the data lines 3. The shaded rectangle in FIG. 2 is the pixel electrode 4. The switches 5 are used to connect with the pixel electrode 4, the scanning lines 2 and the data lines 3.

Wherein, the switch 5 can be a TFT switch.

The display driving circuit 100 according to the embodiment of the present disclosure provides the switch 55 and the pixel electrode 44 at the intersection of the data line 33 and the scanning line 22. When the display panel displays circular patterns, if the scanning lines 2 are annular arrangement, and the data lines 3 are radial arrangement, then the driving process of the display driving circuit is: the driving IC 1 outputting the control signal and the pixel electrode, the scanning lines 2 with annular arrangement corresponding to the annular pattern controlling the switches 5 on the scanning lines 2 to turn on and off sequentially, during the switches 5 corresponding to the scanning lines 2 with annular arrangement turned on, the data lines 3 with radial arrangement charging the pixel electrode 4 on the scanning lines 2 with annular arrangement corresponding to the annular pattern the corresponding pixel voltage. At this time, only several scanning lines 2 corresponding to the annular pattern to be displayed are needed to be driven. Or, When the display panel displays circular patterns, if the scanning lines 2 are radial arrangement, and the data lines 3 are annular arrangement, then the driving process of the display driving circuit is: the driving IC 1 outputting the control signal and the pixel electrode, the scanning lines 2 with radial arrangement controlling the switches 5 corresponding to the annular pattern to turn on and off sequentially, during the switches 5 corresponding to the scanning lines 2 with radial arrangement turned on, the data lines 3 with annular arrangement charging the pixel electrode 4 corresponding to the annular pattern the corresponding pixel voltage. At this time, only several data lines 3 corresponding to the annular pattern to be displayed are needed to be driven.

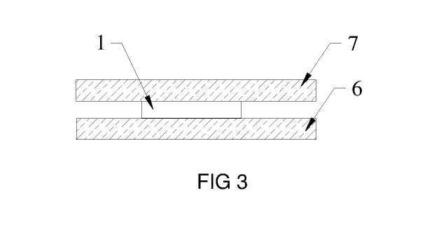

Therefore, in the display driving circuit 100 according to the embodiment of the present disclosure, when the display panel displays circular patterns, only few data lines 3 or scanning lines 2 should be driven, which can simplify the driving procedure of the display driving circuit, and then reduce the power consumption of display driving circuit.

Wherein, also referring to FIG. 3, the display driving circuit 100 according to the embodiment of the present disclosure further comprises a first substrate 6 and a second substrate 7 parallel and spaced with each other, and the driving IC 1 is provided at a central region of the first substrate 6. The scanning lines 2 and the data lines 3 are arranged on the surface of the second substrate 7 close to the driving IC 1.

Wherein, an insulating layer is provided between the scanning lines 2 or the data lines 3 with annular arrangement and the data lines 3 or the scanning lines 2 with radial arrangement. Alternatively, the scanning lines 2 or the data lines 3 with annular arrangement are introduced by the driving IC 1 through a contact hole provided on the insulating layer and arranged in annular on the surface of the insulating layer close to the first substrate 6 or the second substrate 7, the data lines 3 or the scanning lines 2 with radial arrangement are introduced by the driving IC 1 and arranged in radial on the surface of the insulating layer close to the driving IC 1; or, the data lines 3 or the scanning lines 2 with radial arrangement are introduced by the driving IC 1 through a contact hole provided on the insulating layer and arranged in radial on the surface of the insulating layer close to the first substrate 6 or the second substrate 7, the scanning lines 2 or the data lines 3 with annular arrangement are introduced by the driving IC 1 and arranged in annular on the surface of the insulating layer close to the driving IC 1.

Wherein, the scanning line 2 is a gate line, the data line 3 is a source line.

The present disclosure further discloses an embodiment of a display screen. The display screen comprises a display driving circuit of the display screen, the display driving circuit comprising a driving IC 1, multiple scanning lines 2 and multiple data lines 3. One kind of the scanning line and the data line is annular arrangement. The other kind of the scanning line and the data line is radial arrangement. The driving IC 1 is connected to the scanning lines 2 and the data lines 3.

Wherein, the shape of the display screen is circular, round or elliptical.

Wherein, it further comprises multiple switches 5 and multiple pixel electrodes 4, the switches 5 and the pixel electrodes 4 are provided at the intersection of the data lines 3 and the scanning lines 2, the switches 5 are connected to the pixel electrodes 4, the scanning lines 2 and the data lines 3.

Wherein, it further comprises a first substrate 6 and a second substrate 7 parallel and spaced with each other, the driving IC 1 is provided at a central region of the first substrate 6; the scanning lines 2 and the data lines 3 are arranged on the surface of the second substrate 7.

Wherein, the scanning line 2 is a gate line, the data line 3 is a source line.

The present disclosure further discloses an embodiment of a terminal device. The terminal device comprises the embodiment of the display driving circuit 100 or the embodiment of the display screen.

Embodiments of the present disclosure have been described, but not intending to impose any unduly constraint to the appended claims. Any modification of equivalent structure or equivalent process made according to the disclosure and drawings of the present disclosure, or any application thereof, directly or indirectly, to other related fields of technique, is considered encompassed in the scope of protection defined by the claims of the present disclosure.

What is claimed is:

1. An terminal device, comprising a display screen, the shape of the display screen being circular, round or elliptical;
wherein, the display screen comprises a display driving circuit, the display driving circuit comprises a driving IC, multiple scanning lines and multiple data lines; one kind of the scanning line and the data line is annular arrangement; the other kind of the scanning line and the data line is radial arrangement; the driving IC is connected to the scanning lines and the data lines;
wherein, the display driving circuit further comprises multiple switches and multiple pixel electrodes, the switches and the pixel electrodes are provided at the intersection of the data lines and the scanning lines, the switches are connected to the pixel electrodes, the scanning lines and the data lines.

2. The terminal device as claimed in claim 1, wherein the display driving circuit further comprises a first substrate and a second substrate parallel and spaced with each other, the driving IC is provided at a central region of the first substrate; the scanning lines and the data lines are arranged on the surface of the second substrate.

3. The terminal device as claimed in claim 1, wherein the scanning line is a gate line, the data line is a source line.

4. A display driving circuit, comprising a driving IC, multiple scanning lines and multiple data lines; one kind of the scanning line and the data line being annular arrangement; the other kind of the scanning line and the data line being radial arrangement; the driving IC being connected to the scanning lines and the data lines.

5. The display driving circuit as claimed in claim 4, wherein it further comprises multiple switches and multiple pixel electrodes, the switches and the pixel electrodes are provided at the intersection of the data lines and the scanning lines, the switches are connected to the pixel electrodes, the scanning lines and the data lines.

6. The display driving circuit as claimed in claim 4, wherein it further comprises a first substrate and a second substrate parallel and spaced with each other, the driving IC is provided at a central region of the first substrate; the scanning lines and the data lines are arranged on the surface of the second substrate.

7. The display driving circuit as claimed in claim 5, wherein the scanning line is a gate line, the data line is a source line.

8. A display screen, comprising a display driving circuit of the display screen, the display driving circuit comprising a driving IC, multiple scanning lines and multiple data lines; one kind of the scanning line and the data line being annular arrangement; the other kind of the scanning line and the data line being radial arrangement; the driving IC being connected to the scanning lines and the data lines.

9. The display screen as claimed in claim 8, wherein the shape of the display screen is circular, round or elliptical.

10. The display screen as claimed in claim 8, wherein it further comprises multiple switches and multiple pixel electrodes, the switches and the pixel electrodes are provided at the intersection of the data lines and the scanning lines, the switches are connected to the pixel electrodes, the scanning lines and the data lines.

11. The display screen as claimed in claim 8, wherein it further comprises a first substrate and a second substrate parallel and spaced with each other, the driving IC is provided at a central region of the first substrate; the scanning lines and the data lines are arranged on the surface of the second substrate.

12. The display screen as claimed in claim 8, wherein the scanning line is a gate line, the data line is a source line.
